(19) United States
(12) Patent Application Publication
(10) Pub. No.: US 2025/0334607 A1
(43) Pub. Date: Oct. 30, 2025

(54) SCANNING PROBE MICROSCOPE, INFORMATION PROCESSING METHOD, AND PROGRAM

(71) Applicant: SHIMADZU CORPORATION

(72) Inventors: Hiroshi ARAI, Kyoto-shi (JP); Hideo NAKAJIMA, Kyoto-shi (JP); Shiho MORIGUCHI, Kyoto-shi (JP); Chiharu NAKANO, Fukuchiyama-shi (JP)

(21) Appl. No.: 18/695,407

(22) PCT Filed: Mar. 24, 2022
(86) PCT No.: PCT/JP2022/013771

§ 371 Date: Mar. 14, 2025

(30) Foreign Application Priority Data
Sep. 28, 2021 (JP) 2021-158204

(51) Int. Cl. G01Q 30/04; G01Q 10/00

(52) U.S. Cl. CPC G01Q 30/04; G01Q 10/00

(57) ABSTRACT

A scanning probe microscope includes an observation device configured to output an observation signal acquired by observing a sample containing particles, and an information processing device. The information processing device is configured to acquire the observation signal, generate an observation signal based on the observation signal each time the observation signal corresponding to one observation region of the observation device is acquired, count the number of particle images included in the observation image each time the observation image is generated, terminate an acquisition of the observation signal when a counted total number of particle images becomes greater than a predetermined threshold, and execute a particle analysis on a generated observation image.

### TECHNICAL FIELD

The present invention relates to a scanning probe microscope, an information processing method, and a program.

### BACKGROUND ART

Japanese Unexamined Patent Application Publication No. 2000-275159 (Patent Document 1) discloses a scanning probe microscope equipped with an observation device having a probe at a tip of a cantilever, an information processing device, and a display device. The observation device brings the probe close to the sample and scans the probe in the X-axis direction and the Y-axis direction to generate the information on the sample surface, and transmits the information to the information processing device. The information processing apparatus generates image data based on this information and makes the display device display the observation image (the observation image of the sample surface) corresponding to the image data.

### PRIOR ART DOCUMENT

### Patent Document

Patent Document 1: Japanese Unexamined Patent Application Publication No. 2000-275159

### SUMMARY OF THE INVENTION

### Problems to be Solved by the Invention

In some cases, the observation device described above generates image data by observing a sample containing particles, displays an observation image including particle images based on the image data, and performs the particle analysis on the image data. Since the scanning range of the probe is limited by the operable range of the sample movement device (scanner), in the case where the observation range of the sample exceeds the scanning range, the observation of the sample S is sometimes performed by dividing the observation range into N (N is an integer of 2 or more) pieces of regions. In this configuration, each time the observation device completes the observation of one region, the observation device outputs an observation signal corresponding to the region to the information processing device. Then, the information processing device generates N pieces of image data corresponding to the divided regions by generating image data corresponding to the observation signal each time the observation signal is acquired, and executes the particle analysis on the N pieces of image data. In this case, there is a possibility that the information processing apparatus acquires image data more than the number of data required for the particle analysis, which may result in a significant amount of time until the particle analysis is completed.

The present invention has been made to solve the above-described problems. The purpose of the present invention is to provide a technique capable of reducing the time required to complete a particle analysis while maintaining the analysis accuracy.

### Means for Solving the Problems

A scanning probe microscope according to an aspect of the present disclosure is provided with an observation device that outputs an observation signal acquired by observing the sample containing particles, and an information processing device. The information processing device acquires an observation signal, generates an observation image based on the observation signal each time the information processing device acquires the observation signal corresponding to one observation region of the observation device, counts the number of particle images included in the observation image each time the observation image is generated, and terminates an acquisition of the observation signal when a counted total number of particle images becomes larger than a predetermined threshold. Then, the information processing device executes a particle analysis on a generated observation image.

### Effects of the Invention

According to the technology of the present disclosure, the acquisition of the observation signal is terminated when the counted total number of particle images in each divided observation region becomes larger than a set threshold, and a particle analysis is performed on the observation image generated based on the observation signal. Therefore, according to the technology of the present disclosure, the time to complete the particle analysis can be reduced while maintaining the accuracy of the particle analysis.

### BRIEF DESCRIPTION OF THE DRAWINGS

FIG. 1 is a diagram schematically showing a configuration of a scanning probe microscope according to an embodiment.

FIG. 2 is a diagram showing one example of a hardware configuration of an information processing device.

FIG. 3 is one example of a functional block diagram of an information processing device.

FIG. 4 is one example of a screen for setting an upper limit of a particle image.

FIG. 5 is one example of a flowchart executed by an information processing device.

FIG. 6 is one example of a list screen of observation images.

### EMBODIMENTS FOR CARRYING OUT THE INVENTION

Hereinafter, some embodiments of the present invention will be described with reference to the attached drawings. Note that, hereinafter, the same or equivalent part in the figures is assigned by the same reference symbol, and the description thereof will not be repeated.

### [Configuration of Scanning Probe Microscope]

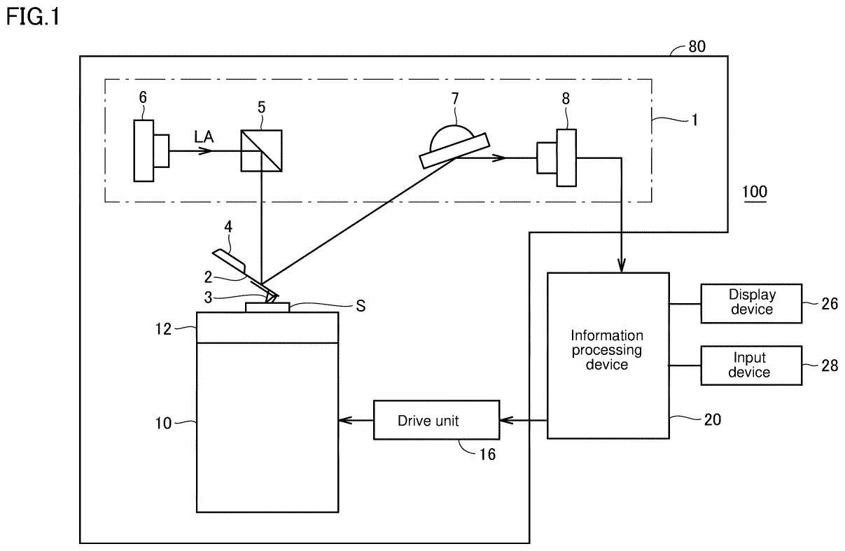

FIG. 1 is a diagram schematically showing a configuration of a scanning probe microscope according to an embodiment. The scanning probe microscope 100 according to the embodiment is an atomic force microscope (AFM) for observing a sample S using the interatomic force (attraction or repulsion) that acts between the probe (probe needle) and the surface of the sample S.

Referring to FIG. 1, the scanning probe microscope 100 according to this embodiment is equipped with, as its main constituent elements, an observation device 80, an information processing device 20, a display device 26, and an input device 28. The observation device 80 has, as its main constituent elements, an optics 1, a cantilever 2, a scanner 10, a sample holder 12, and a drive unit 16.

The scanner 10 has a cylindrical shape and is a moving device for changing the relative positional relation between the sample S and the probe 3. The sample S is held on the sample holder 12 placed on the scanner 10. The scanner 10 has an XY scanner that scans the sample S in the two mutually orthogonal X- and Y-axis directions, and a Z scanner that moves the sample S slightly in a Z-axis direction orthogonal to the X-axis and the Y-axis. The XY scanner and the Z scanner are composed of piezoelectric elements configured to be deformed by the voltage applied from the drive unit 16, and the scanner 10 scans in the three-dimensional directions (X-axis direction, Y-axis direction, and Z-axis direction) according to the voltage applied to the piezoelectric elements. With this, the relative positional relation between the sample S placed on the scanner 10 and the probe 3 can be changed.

The cantilever 2 has a front surface facing the sample S and a back surface opposite the front surface and is supported by the holder 4. The cantilever 2 has a probe 3 on the surface of the tip end, which is a free end. The probe 3 is arranged to face the sample S. The cantilever 2 is displaced in the Z-axis direction by the interatomic force acting between the probe 3 and the sample S.

Above the cantilever 2, an optics 1 for detecting the displacement of the cantilever 2 in the Z-axis direction is provided. The optics 1 emits laser light onto the back surface of the cantilever 2 and detects the laser light reflected from the back surface of the cantilever 2 during the observation of the sample S. The optics 1 has a laser light source 6, a beam splitter 5, a reflector 7, and a photodetector 8.

The laser light source 6 has a laser oscillator that emits the laser light. The photodetector 8 has a photodiode for detecting the incident laser light. The laser light LA emitted from the laser light source 6 is reflected by the beam splitter 5 and emitted onto the back surface of the cantilever 2.

The back surface of the cantilever 2 is a mirror surface and can reflect the laser light emitted from the optics 1. The laser light reflected by the back surface of the cantilever 2 is further reflected by the reflector 7 and incident on the photodetector 8. The displacement of the cantilever 2 can be detected by detecting the laser light with the photodetector 8.

Specifically, the photodetector 8 has a light-receiving surface divided into a plurality (usually two) of sections in the displacement direction (Z-axis direction) of the cantilever 2. Alternatively, the photodetector 8 has a light-receiving surface divided into four sections in the Z-axis direction and the Y-axis direction. As the cantilever 2 is displaced in the Z-axis direction, the ratio of the amount of light emitted to the plurality of light-receiving surfaces changes. The photodetector 8 outputs the detection signals corresponding to the plurality of received light amounts to the information processing device 20. The detection signal corresponds to the “observation signal” of the present disclosure.

The information processing device 20 is communicatively connected to the optics 1, the drive unit 16, the display device 26, and the input device 28. The information processing device 20 generates image data based on the detection signals output from the photodetector 8 over a given observation region. In the case of observing the sample S containing particles with the scanning probe microscope 100, assuming that the particles are spherical in shape, the displacement amount (deflection amount) of the cantilever 2 in the Z-axis direction indicates the diameter of the particle.

The information processing device 20 makes the display device 26 display the observation image based on the generated image data. The observation image is an image showing the surface of the sample S. Further, the information processing device 20 controls the drive unit 16 to drive the scanner 10 in the three-dimensional directions.

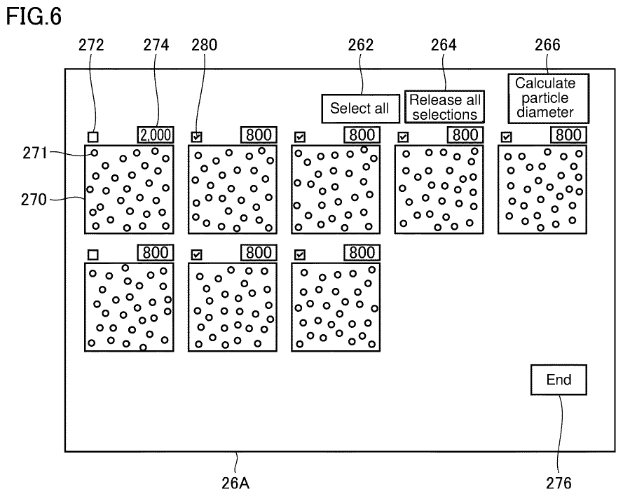

The scanning range of the XY scanner in the X-axis direction and the Y-axis direction is limited by the operable range of the piezoelectric element. Therefore, in the case where the observation range of the sample S exceeds this scanning range, the scanning probe microscope 100 divides the observation range into N (N is an integer equal to or greater than 2) pieces of regions to observe the sample S. In the case where the scanning probe microscope 100 observes the sample S by dividing the observation range into N pieces of regions, the observation device 80 outputs the detection signals corresponding to N pieces of regions obtained by each observation to the information processing device 20. The information processing device 20 generates N pieces of image data based on the detection signal for each of the N pieces of regions. The information processing device 20 displays a list of observation images corresponding to the N pieces of image data on the display device 26 configured by a liquid crystal panel or the like. Hereafter, the image of each particle included in the observation image is referred to as the “particle image (particle image 271 shown in the following FIG. 6).

The input device 28 receives a user's input operation. The input device 28 outputs the signal corresponding to the user's operation to the information processing device 20. The input device 28 may be a touch panel provided on the display device 26 or may be a dedicated control button, or physical operation keys, such as a mouse and a keyboard.

### [Hardware Configuration of Information Processing Device]

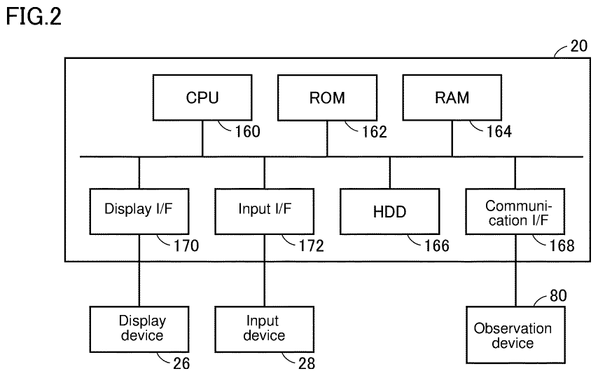

FIG. 2 is a diagram showing one example of the hardware configuration of the information processing device 20. The information processing device 20 has, as its main constituent elements, a CPU (Central Processing Unit) 160, a ROM (Read Only Memory) 162, a RAM (Random Access Memory) 164, an HDD (Hard Disk Drive) 166, a communication I/F (interface) 168, a display I/F 170, and an input I/F 172. Each constituent element is interconnected by a data bus. Note that at least a part of the hardware configuration of the information processing device 20 may be provided inside the observation device 80. Alternatively, the information processing device 20 may be configured as a unit separated from the scanning probe microscope 100, and may be configured to communicate bidirectionally with the scanning probe microscope 100.

The communication I/F 168 is an interface for communicating with the observation device 80. The display I/F 170 is an interface for communicating with the display device 26. The input I/F 170 is an interface for communicating with the input device 28.

The ROM 162 stores a program to be executed by the CPU 160. The RAM 164 can temporarily store the data generated by executing the program in the CPU 160 and the data input via the communication I/F 168. The RAM 164 can function as a temporary data memory used as a work region. The HDD 166 is a nonvolatile storage device. Further, in place of the HDD 166, a semiconductor storage device, such as flash memory, may be employed.

Further, the program stored in the ROM 162 may be stored in a recording medium and distributed as a program product. Alternatively, the program may be provided by an information provider as a program product that can be downloaded via the so-called Internet or other means. The information processing device 20 reads a program provided by a recording media or the Internet. The information processing device 20 stores the read program in a predetermined storage area (e.g., the ROM 162). The CPU 160 executes the above-described display processing by executing the stored program.

The recording media is not limited to a DVD-ROM (Digital Versatile Disk Read Only Memory), a CD-ROM (compact disc read-only memory), an FD (Flexible Disk), and a hard disk, but may be a medium capable of fixedly carrying a program, such as a semiconductor memory, exemplified by e.g., a magnetic tape, a cassette tape, an optical disk (MO (Magnetic Optical Disc)/MD (Mini Disc)/DVD (Digital Versatile Disc)), an optical card, a mask ROM, an EPROM (Electrically Programmable Read-Only Memory), an EEPROM (Electrically Erasable Programable Read-Only Memory), and a flash ROM. Further, a recording medium is a non-transitory medium in which a computer can read a program, etc.

### [Processing of Information Processing Device]

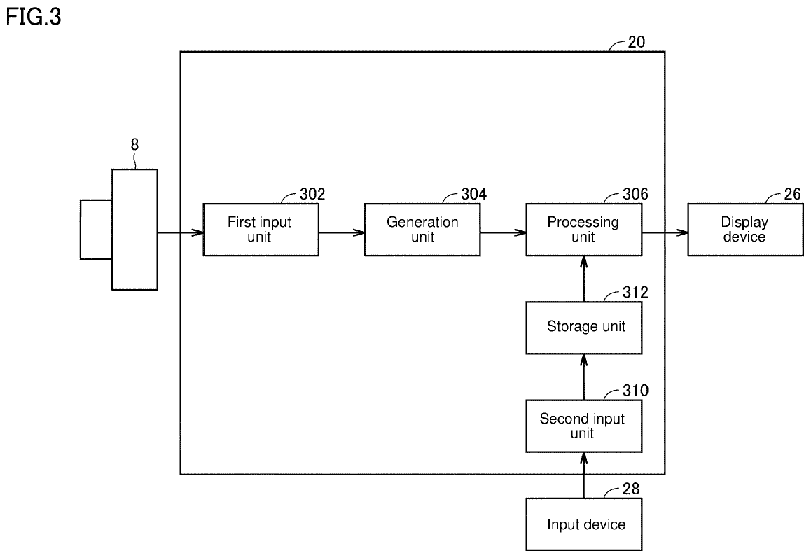

FIG. 3 is one example of a functional block diagram of the information processing device 20. The information processing device 20 includes a first input unit 302, a generation unit 304, a processing unit 306, a second input unit 310, and a storage unit 312.

The first input unit 302 receives a detection signal input from the photodetector 8 and outputs a detection signal to the generation unit 304. The generation unit 304 generates image data based on the detection signal and outputs image data to the processing unit 306. The processing unit 306 makes the display device 26 display the observation image based on the image data. In the case where the scanning probe microscope 100 observes the sample S by dividing into N times, the processing unit 306 makes the display device 26 display a list of N pieces of observation images corresponding to each of the N pieces of divided observation regions. Note that the number N of divisions of the observation range may be set by the user or automatically set by the information processing device 20.

The processing unit 306 executes predetermined analysis processing on the image data of the sample S. The predetermined analysis processing includes a particle analysis. The particle analysis includes, for example, the processing of counting the particle images contained in the observed image (hereinafter also referred to as “counting processing”). Further, the particle analysis includes, for example, the processing of generating data of a histogram showing the relation between the particle diameter of the particles contained in all observation images of the sample S and the number of the particle images having the particle size. The particle analysis may include other processing other than the above. The user can select the particle analysis to be executed by the information processing device 20.

The user can select an observation image to be a target of the analysis processing from among the N pieces of observation images displayed on the display device 26. The user selects an observation image to be a target of the analysis processing using the input device 28 while viewing the list of observation images displayed on the display device 26. The second input unit 310 receives the input information input by the user from the input device 28. This input information is information showing the observation image selected by the user. The input information is once stored in the storage unit 312. The processing unit 306 executes analysis processing on the image data of the observation image (i.e., the observation image selected by the user) indicated by the input information. This configuration allows the user to have the information processing device 20 execute the analysis processing for the observation image selected by the user.

By the way, there is a case in which the number of particles per unit area of a sample S is fixed to some extent in terms of the specification, etc., of the sample S. In this case, the user can estimate the approximate number (hereinafter also referred to as the “required number”) of particle images required for the particle analysis. Such a sample S is, for example, an abrasive. Hereinafter, the case in which the scanning probe microscope 100 observes an abrasive is described.

In a conventional scanning probe microscope, even after the information processing device has generated image data exceeding the required number of images, the observation for all of the observation regions (i.e., N pieces of observation regions) scheduled to be acquired in advance is continued until the observation is completed even after the number of particle images in the generated image data has reached the number required for the particle analysis. A particle analysis is executed after completion of all of the observations in the scanning probe microscope, and therefore, the information processing device may have acquired image data more than necessary for the particle analysis. As a result, in some cases, the time required to complete the particle analysis can be significant.

In response to these issues, it is possible to configure such that a user can set an upper limit for the image data generated by the information processing device. However, in this configuration, the information processing device continuously acquires detection signals until the upper limit of image data set by the user is reached even after the information processing device has generated more than the required number of particle images. Further, in cases where the observation images corresponding to the generated image data contain extremely few particle images, when the number of image data generated by the information processing device has reached the upper limit, the information processing device will terminate the acquisition processing of the detection signal even though the number of particle images necessary for the particle analysis has not been collected. As a result, there is a problem that the information processing device cannot perform the particle analysis with high accuracy.

Therefore, the scanning probe microscope 100 in this embodiment is configured to allow the user to set an upper limit for the number of particle images required for the particle analysis. And the information processing device 20 terminates the acquisition of detection signals when the total number of particle images included in the observation image corresponding to each of the generated image data becomes larger than the upper limit. With this, the number of particle images that can secure the analysis accuracy can be acquired, and the acquisition of the number of particle images more than necessary is suppressed, and the particle analysis is initiated promptly. Therefore, the time until the particle analysis is completed can be shortened while maintaining the analysis accuracy.

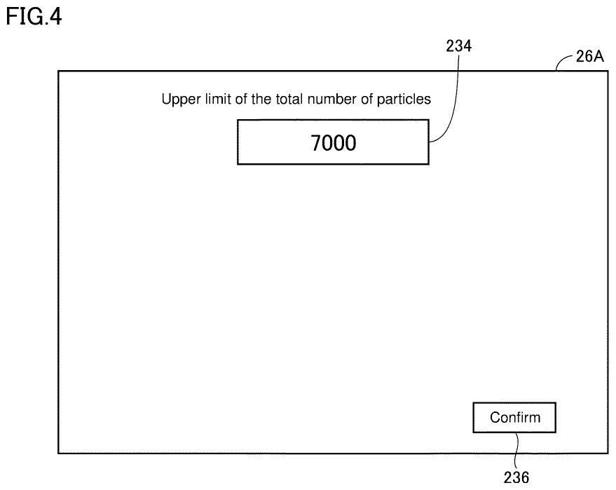

FIG. 4 shows one example of a screen for setting an upper limit of a particle image. The setting screen shown in FIG. 4 is displayed in the display region 26A of the display device 26 when the user performs a predetermined operation on the input device 28 to display the setting screen.

Referring to FIG. 4, the setting screen includes an input region 234 and a confirm button 236. Further, the user uses the input device 28 to input the upper limit for the total number of particle images in the input region 234. When the confirm button 236 is operated by the user after inputting the upper limit value, the second input unit 310 receives the input of this upper limit value and makes the storage unit 312 store the received upper limit value. Thus, the desired upper limit can be set by the user. In the example shown in FIG. 4, an example in which 7,000 is set as the upper limit is shown.

### [Flowchart of Information Processing Device]

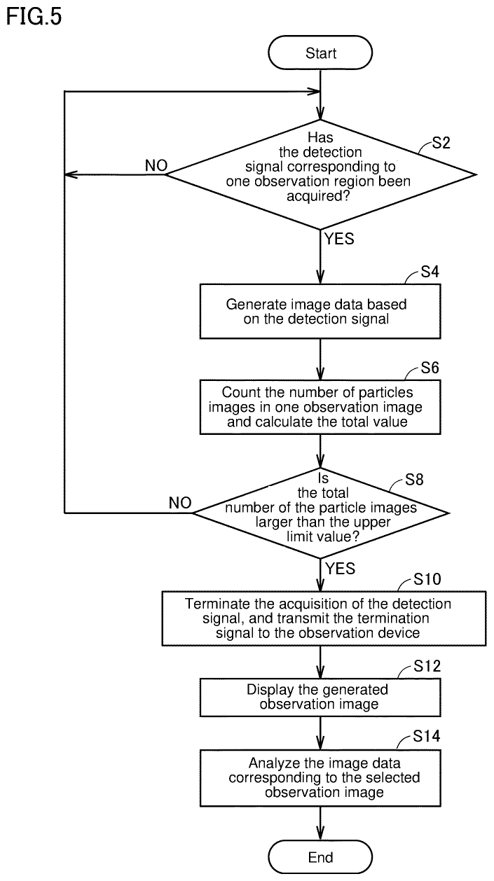

FIG. 5 shows one example of a flowchart of the information processing device 20. The processing in FIG. 5 is initiated, for example, when a predetermined start operation is performed by the user on the scanning probe microscope 100. Referring to FIG. 5, in Step S2, the information processing device 20 determines whether it has acquired a detection signal corresponding to one observation region from the photodetector 8 of the observation device 80. The information processing device 20 repeats the processing of Step S2 until it acquires a detection signal. In Step S4, the generation unit 304 of the information processing device 20 generates image data based on the acquired detection signal.

Next, in Step S6, the processing unit 306 counts the particle images included in the observation image corresponding to the generated image data. The processing unit 306 adds the counted number ΔM of particle images to the total number M of particle images, thereby updating the total value (M=M+ΔM). The updated total value M is stored in the storage unit 312.

Next, in Step S8, the processing unit 306 of the information processing device 20 determines whether the total number M of particle images is greater than the upper limit value set by the user. In the case where the total number M of particle images is equal to or less than the upper limit value (NO in Step S8), the processing unit 306 returns the processing to Step S2. Thereafter, the processing from Step S2 to Step S6 is repeated to increase and update the total value M.

In Step S8, when the total number M of particle images exceeds the upper limit value (YES in Step S8), the processing proceeds to Step S10. In Step S10, the information processing device 20 terminates the acquisition of the detection signal output from the observation device 80. Further, in Step S10, the information processing device 20 transmits a termination signal for terminating the observation processing of the observation device 80 to the observation device 80. Upon receipt of the termination signal, the observation device 80 terminates the observation processing.

Next, in Step S12, the processing unit 306 makes the display device 26 display the generated observation image. FIG. 6 shows one example of the list screen displayed in Step S12 of FIG. 5. The list screen of the example shown in FIG. 6 displays eight pieces of observation images 270. Each of the observation images 270 includes one or more particle images 271. Corresponding to each of the eight observation images 270, a checkbox 272 and a display region 274 for displaying the number of particle images are displayed. In addition, a selection button 262, a release button 264, a particle diameter calculation button 266, and an end button 276 are displayed.

In the display region 274, the number of particle images included in the observation image corresponding to the display region 274 is displayed. In the example shown in FIG. 6, one piece of an observation image in which the number of particle images is 2,000, and seven pieces of observation images in which the number of particle images is 800 are displayed.

By clicking on the checkbox 272, the user can show or hide the check mark 280 in the checkbox 272.

When the particle diameter calculation button 266 is operated, in Step S14 of FIG. 5, the processing unit 306 executes analysis processing (in the example of FIG. 6, calculation of particle diameter) on the image data corresponding to the observation image in which the check mark 280 is displayed. On the other hand, the processing unit 306 does not execute analysis processing on the image data corresponding to the observation image in which no check mark 280 is displayed.

Further, when the selection button 262 is operated, check marks 280 are shown in all of the checkboxes 272 at once. Further, when the release button 264 is operated, the check marks 280 displayed in all of the checkboxes 272 for the appropriate observation images will be hidden at once. In this way, the check marks 280 can be displayed or hidden at once, so that the user's convenience can be improved. Further, when the end button 276 is operated, the list screen transits to another screen (e.g., the home screen).

As shown in Step S8, Step S10, etc., in FIG. 5, the scanning probe microscope 100 terminates the acquisition of detection signals when the total number of particle images becomes greater than the upper limit. The processing unit 306 executes the particle analysis on the image data generated based on the acquired detection signal. Therefore, the scanning probe microscope 100 according to this embodiment can, for example, reduce the time until the particle analysis is completed, as compared with the case of performing the observation of all observation regions. Further, in the scanning probe microscope 100, since the total number of particle images is greater than the upper limit value, the accuracy of particle analysis can be ensured since the number of particle images required for the particle analysis has been collected.

As shown in Step S10 of FIG. 5, when the information processing device 20 completes the acquisition of the detection signal, it transmits the termination signal to the observation device 80. Upon receipt of the termination signal, the observation device 80 terminates the observation processing. Therefore, the information processing device 20 can prevent the observation device 80 from performing unnecessary observation processing.

Further, as shown in FIG. 6, the display device 26 displays a list of observation images so that they can be selected by the user. Therefore, the particle analysis can be performed on the image data of the observation image desired by the user, thus improving the user's convenience.

### OTHER EMBODIMENTS

(1) In the above-described embodiment, the configuration is shown in which the upper limit value is set for the number of particle images was described. However, a configuration may be employed in which the lower limit value for the number of particle images is set. In this configuration, the upper limit value in Step S8 of FIG. 5 is substituted for the “lower limit value.” Note that the upper or lower limit value mentioned above corresponds to the “threshold” in this disclosure.

(2) In the above-described embodiment, a configuration was described in which the user sets the threshold (upper or lower limit value) (see FIG. 4, etc.). However, the processing unit 306 of the information processing device 20 may automatically set the threshold. For example, in a case where a sample ID (identification) is assigned to each of a plurality of samples S and a threshold is stored for each sample ID in advance, when the user inputs the sample ID using the input device 28, the information processing device 20 automatically sets the threshold corresponding to the input sample ID. This configuration can reduce the burden of setting the threshold by the user.

(3) In the above-described embodiment, the information processing device 20 displays a list of observation images on the display device 26 and allows the user to select an observation image to be the target of particle analysis. However, the information processing device 20 may execute analysis processing on the generated image data without displaying a list of observation images.

(4) In the above-described embodiment, the configuration was described in which the concept of this embodiment is employed in a scanning probe microscope. However, the concept of this embodiment may be employed in a microscope (e.g., scanning confocal laser microscope) other than a scanning probe microscope.

### Aspects

It would be understood by those skilled in the art that the plurality of exemplary embodiments described above is specific examples of the following aspects.

### (Item 1)

The scanning probe microscope according to one aspect is provided with an observation device configured to output an observation signal acquired by observing a sample containing particles, and an information processing device,
wherein the information processing device is configured to
acquire the observation signal,
generate an observation signal based on the observation signal each time the observation signal corresponding to one observation region of the observation device is acquired,
count the number of particle images included in the observation image each time the observation image is generated,
terminate an acquisition of the observation signal when a counted total number of particle images becomes greater than a predetermined threshold, and
execute a particle analysis on a generated observation image.

According to the scanning probe microscope as recited in the above-described Item 1, the acquisition of observation signals is terminated when the counted total number of particle images in each divided observation region becomes larger than a set threshold, and the particle analysis is executed on the observation images generated based on the observation signal. Therefore, according to the technology of this disclosure, the time to complete the particle analysis can be reduced while maintaining the accuracy of the particle analysis.

### (Item 2)

In the scanning probe microscope as recited in the above-described Item 1, the information processing device receives the threshold from a user and sets the threshold received from the user in the storage unit.

According to the scanning probe microscope as recited in the above-described Item 1, the user can set a threshold. Therefore, it is possible to have the information processing device execute the particle analysis that reflects the threshold desired by the user.

### (Item 3)

In the scanning probe microscope as recited in the above-described Item 1 or Item 2, the information processing device transmits a termination signal for terminating an observation to the observation device in response to the completion of the acquisition of the observation signal.

According to the scanning probe microscope as recited in the above-described Item 3, it is possible to prevent the observation device from executing unnecessary observation processing.

### (Item 4)

The scanning probe microscope is further provided with a display device controlled by the information processing device, and the information processing device is configured to
make the display device display generated observation images, and
execute the particle analysis on an observation image selected by a user among the observation images displayed on the display device.

According to the scanning probe microscope as recited in the above-described Item 4, it is possible to prevent the observation device from executing unnecessary observation processing. Therefore, the particle analysis can be performed on the image data of the observation image desired by the user, thus improving the user's convenience.

### (Item 5)

An information processing method by an information processing device, the information processing device being capable of communicating with an observation device that outputs an observation signal acquired by observing a sample containing particles, the information processing method comprising:
a step of acquiring the observation signal;
a step of generating an observation image based on the observation signal each time the observation signal corresponding to one observation region of the observation device is acquired;
a step of counting the number of particle images included in the observation image each time the observation image is generated;
a step of terminating an acquisition of the observation signal when a counted total number of particle images becomes greater than a predetermined threshold, and
a step of executing a particle analysis on the generated observation image.

According to the control method as recited in the above-described Item 5, the acquisition of observation signals is terminated when the counted total number of particle images in each divided observation region becomes larger than a set threshold, and the particle analysis is executed on the observation images generated based on the observation signal. Therefore, according to the technology of this disclosure, the time to complete the particle analysis can be reduced while maintaining the accuracy of the particle analysis.

### (Item 6)

A program for making a computer execute steps, the computer being capable of communicating with an observation device that outputs an observation signal acquired by observing a sample containing particles, the steps including:
a step of acquiring the observation signal;
a step of generating an observation image based on the observation signal each time the observation signal corresponding to one observation region of the observation device is acquired;
a step of counting the number of particle images included in the observation image each time the observation image is generated;
a step of terminating an acquisition of the observation signal when a counted total number of particle images becomes greater than a predetermined threshold; and a step of executing a particle analysis on the generated observation image.

According to the program as recited in the above-described Item 6, the acquisition of observation signals is terminated when the counted total number of particle images in each divided observation region becomes larger than a set threshold, and the particle analysis is executed on the observation images generated based on the observation signal. Therefore, according to the technology of this disclosure, the time to complete the particle analysis can be reduced while maintaining the accuracy of the particle analysis.

Each of the disclosed embodiments is planned to be implemented in combination as appropriate to the extent that it is not technically inconsistent. Note that the embodiments disclosed here should be considered illustrative and not restrictive in all respects. It should be noted that the scope of the embodiments is indicated by claims and is intended to include all modifications within the meaning and scope of the claims and equivalents.

Description of Reference Symbols

| | |
|---|---|
| 1: | Optics |
| 2: | Cantilever |
| 3: | Probe needle |
| 4: | Holder |
| 5: | Beam splitter |
| 6: | Laser light source |
| 7: | Reflector |
| 8: | Photodetector |
| 10: | Scanner |
| 12: | Sample holder |
| 16: | Drive unit |
| 20: | Information processing device |
| 26: | Display device |
| 28: | Input device |
| 80: | Observation device |
| 100: | Scanning probe microscope |
| 162: | ROM |
| 164: | RAM |
| 234: | Input region |
| 236: | Confirm button |
| 262: | Selection button |
| 264: | Release button |
| 266: | Particle size calculation button |
| 270: | Observation image |
| 271: | Particle image |
| 272: | Checkbox |
| 276: | End button |
| 280: | Check |
| 302: | First input unit |
| 304: | Generation unit |
| 306: | Processing unit |
| 310: | Second input unit |
| 312: | Storage unit |

1. A scanning probe microscope comprising:
an observation device configured to output an observation signal acquired by observing a sample containing particles; and
an information processing device,
wherein the information processing device is configured to
acquire the observation signal,
generate an observation image based on the observation signal each time the observation signal corresponding to one observation region of the observation device is acquired,
count the number of particle images included in the observation image each time the observation image is generated,
terminate an acquisition of the observation signal when a counted total number of particle images becomes greater than a predetermined threshold, and
execute a particle analysis on a generated observation image.

2. The scanning probe microscope as recited in claim 1,
wherein the information processing device is configured to
receive the threshold from a user, and
set the threshold received from the user in a storage unit.

3. The scanning probe microscope as recited in claim 1,
wherein the information processing device transmits a termination signal for terminating an observation to the observation device in response to a termination of acquiring the observation signal.

4. The scanning probe microscope as recited in claim 1, further comprising:
a display device controlled by the information processing device,
wherein the information processing device is configured to
make the display device display generated observation images, and
execute the particle analysis on the observation image selected by a user among the observation images displayed on the display device.

5. An information processing method by an information processing device, the information processing device being capable of communicating with an observation device that outputs an observation signal acquired by observing a sample containing particles, the information processing method comprising:
a step of acquiring the observation signal;
a step of generating an observation image based on the observation signal each time the observation signal corresponding to one observation region of the observation device is acquired;
a step of counting the number of particle images included in the observation image each time the observation image is generated;
a step of terminating an acquisition of the observation signal when a counted total number of particle images becomes greater than a predetermined threshold; and
a step of executing a particle analysis on the generated observation image.

6. A program for making a computer execute steps, the computer being capable of communicating with an observation device that outputs an observation signal acquired by observing a sample containing particles, the steps including:
a step of acquiring the observation signal;
a step of generating an observation image based on the observation signal each time the observation signal corresponding to one observation region of the observation device is acquired;
a step of counting the number of particle images included in the observation image each time the observation image is generated;
a step of terminating an acquisition of the observation signal when a counted total number of particle images becomes greater than a predetermined threshold; and
a step of executing a particle analysis on the generated observation image.
